(19) United States
(12) Patent Application Publication
(10) Pub. No.: US 2025/0198438 A1
(43) Pub. Date: Jun. 19, 2025

(54) FIXING OF PET PANELS TO ALLOW FOR RECYCLING

(71) Applicant: AUTEX INDUSTRIES LIMITED, AUCKLAND (NZ)

(72) Inventor: Luke Clifford WALKER, Auckland (NZ)

(21) Appl. No.: 18/979,293

(22) Filed: Dec. 12, 2024

(30) Foreign Application Priority Data
Dec. 15, 2023 (NZ) 806637

(51) Int. Cl. F16B 5/02; B29B 17/04; B29C 65/06; B29K 67/00; B29L 31/00

(52) U.S. Cl. CPC F16B 5/0208; B29B 17/0412; B29C 65/0672; B29K 2067/003; B29L 2031/776

(57) ABSTRACT

A method of recycling/upcycling needle punched PET panels or baffles makes use of a plurality of injection moulded PET components capable of being attached to a needle punched PET panel by plastic welding and to be removably attachable to complementary components fixed or fixable to a support. Spin welding allows the injection moulded PET components to be installed on site or in the factory. The PET panel with its now welded PET components can be press fitted to the complementary components fixed on the wall. A modified form of PET fixing component allows for a suspended baffle or panel. The PET panel or baffle with its PET components welded thereto can be recycled/upcycled without needing to remove the PET components from the panel as they are uncontaminated by any adhesive.

### FIELD OF THE INVENTION

The invention relates to a method fixing of needle punched PET products to a wall or other support to allow for recycling/upcycling or replacement, and also relates to the components to be used in this new method.

### BACKGROUND OF INVENTION

This invention relates in particular to methods and/or components for the attachment of needle punched PET panels or baffles to a support such as a suspension system so that the panels or baffles can be suspended and held in a horizontal plane, or can be attached to walls or furniture where they will typically be held in a vertical plane. Needle punched PET panels can be decorative and provide good sound absorption properties.

Needle punched PET products can be produced in a variety of sizes, shapes, and thicknesses. We use the term “products” to imply a degree of rigidity or stiffness that is not present in needle punched fabrics. These needle punched products are used mainly for acoustic purposes but can also be used for decorative and in some cases for thermal insulation. They are typically produced as panels, tiles, suspended baffles, screens, or dividers between workstations.

PET is the common abbreviation for—poly ethylene terephthalate.

PET, unlike natural polymers, is a non-degradable polymer in the natural environment leading to environmental pollution when it is discarded after use. Consequently, it is desirable to recycle (sometimes called upcycle) it wherever possible.

However existing methods of attaching them to walls or furniture typically involves the use of an adhesive, so that removal of the panels, for example if one is damaged and needs to be replaced, or if the fit-out needs to be changed, often results in damage to the underlying support, e.g. a plasterboard wall, or parts of the furniture structure.

More importantly, the use of an adhesive to secure a PET panel to a support, renders the removed panel as unable to be recycled as the adhesive does not comply with standards relating to the recycling of PET material.

If fasteners such as screws are used, e.g. through the panels, then damage to the PET panel can occur rendering it unsightly, and requiring careful removal and separation from the panels prior to recycling.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### OBJECT OF THE INVENTION

It is an object of the invention to provide a method and components for fixing of PET panels to a support that allows for recycling of the PET panels, or which ameliorates some of the disadvantages and limitations of the known art or at least provide the public with a useful choice.

### SUMMARY OF INVENTION

In general, the invention involves novel products and a novel method of a fixing of needle punched PET products such as panels or baffles to a support to allow for recycling of the needle punched PET product without contamination by a glue.

In a first aspect the invention provides a method of fixing a PET panel to a support in which a PET fixing component is attached to the rear surface of the PET panel by plastic welding, and a complementary fixing component is attached to the support, so that the two complementary components can be attached together.

This can be on the surface of the panel or recessed into the panel. In the latter case it is preferred that the depth of the PET component is less than the thickness of the panel.

This has the advantage that the panel can be connected to the support, and if it is removed from the support by pulling the complementary fixing components apart, the entire PET panel can be recycled together with the PET fixing components welded thereto.

The preferred method of plastic welding is friction/spin welding particularly if the components are to be welded on site. In which case it is preferred that the PET component to be welded to the PET panel is circular in outline.

Preferably the PET fixing component is made from recycled PET panel, so that the recycled material can be used in an injection moulding process to produce the PET fixing component.

Preferably the PET fixing component is designed to be a press fit to the complementary fixing component and more preferably both components can be injection moulded using the recycled PET material.

In another aspect he invention provides a PET fixing component capable of being attached to a PET panel by plastic welding without the use of any glue which would otherwise contaminate the panel and prevent it from being recycled.

Preferably the attachment is by way of friction welding.

Preferably the PET fixing component is capable of being press fitted to a complementary component capable of being fixed to a wall or other surface. The complementary component need not be made of the same material as the PET fixing component (though as noted below we believe it is useful to make both components from recycled PET) and may in some circumstances be left on the wall when the PET panel and the PET fixing components are removed for recycling.

Preferably the PET fixing component is made from recycled PET panel, so that the recycled material can be used in an injection moulding process to produce the PET fixing component.

Preferably both components can be injection moulded using the recycled PET material.

Preferably both fixing components are circular in outline and designed to be press fit together. By making the PET fixing component of a generally circular shape it can be fitted to a chuck of an electric drill, so that it can be rotated by the drill to create friction between the PET component and the rear face of the PET panel. The rotational friction is sufficient to cause part of the PET panel or possibly part of the PET fixing component (or both) to melt together so that the PET fixing component is securely fixed to the back of the PET panel.

The invention also applies to PET panels supplied with the PET fixing components pre-welded to the rear face of each panel.

The invention also applies to the recycling/upcycling PET panels having the PET fixing components welded thereto.

### DEFINITIONS

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.
Mechanical Connection: refers to an adhesive free connection between components, typically as a push fit, or a bayonet or screw fitting so that he components can be connected together or disconnected when needed.
PET refers to poly ethylene terephthalate.
“PET fixing component” as used herein refers to a component made of PET (whether virgin PET or recycled PET) which can be attached to a PET panel without the use of an adhesive.
Needle punched PET products refer to those with sufficient stiffness to be suspended or mounted to a wall, ceiling or furniture. They are typically supplied as panels, tiles, suspended baffles, screens, or dividers between workstations.
Needle punched PET Panel-low density—typically from 72-100 kg/m³
Needle punched PET Panel-medium density—typically from 100-149 kg/m³
Needle punched PET Panel-high density—typically from 150-400 kg/m³
Injection moulded PET components typically have a density of about 1370 kg/m³.
Plastic welding means the joining of two similar plastic components together by heat to allow one or both components to melt and fuse together. Various ways of generating heat can be used including friction or spin welding, ultrasonic welding, lasers, high frequency welding, vibration welding, hot plate welding, hot gas welding, etc.
Friction welding means the joining the two components by the heat generated by friction resulting from the movement of one component relative to the other.
Front face—the visible face of the panel.
Rear face—the face of the panel which is usually hidden as it is to be in contact with a support structure (e.g. an overhead support beam/channel or a vertical wall)
Spin welding is the name for a particular type of friction welding where one component is rotated and pressed against another typically static component.
Ultrasonic welding is the name for a particular type of friction welding where two components are pressed together with ultrasonic vibrations causing one or other of the components to move rapidly relative to, the other.

### BRIEF DESCRIPTION OF THE DRAWINGS

The invention will now be described, by way of example only, by reference to the accompanying photographs/drawings:

FIG. 1 shows the PET fixing component (on top) with its spike uppermost (this side is the side to be attached to the PET panel) and also shows the complementary fixing component at the bottom of this figure (this is the component to be secured to a wall).

FIG. 1A shows the opposite faces of both the PET fixing component (on the top) and the complementary fixing component, (below).

FIG. 2 shows the complementary fixing component dis-assembled to show its flexi-core and outer ring.

FIG. 2A shows the opposite faces of the dis-assembled complementary fixing component.

FIGS. 3 to 6 inclusive show a sequence used in an on-site instal surface mount method:

FIG. 3A shows the two parts of the complementary component being screwed to a wall.

FIG. 3B shows the assembled two part complementary component secured in place.

FIG. 3C shows the temporary placement of the PET component being clipped onto the complementary component so that its spike is facing away from the wall.

FIG. 3D shows the PET fastener temporarily in place.

FIG. 4A shows placement of a PET panel in a desired location to be pushed against the wall.

FIG. 4B shows pressure applied to the panel so that it engages the spikes of the fixed complementary fasteners to mark locations on the panel.

FIG. 4C shows the depressions on the panel from the spikes.

FIG. 4D shows removal of the push fit PET fasteners form the complementary fasteners.

FIG. 5A shows the placement of a PET fastener into a setting tool (with an exploded view on the left and an assembled view on the right)

FIG. 5B shows the drill and setting tool being lowered onto the panel so that the spike of the PET component can be located in the depression (marked as shown in FIG. 4C).

FIG. 5C shows the rotation of the setting tool by the drill and pressure applied to the PET component against the rear face of the PET panel.

FIG. 5D shows disengagement of the setting tool form the now plastic welded PET component.

FIG. 6A shows the PET panel with its plastic welded PET components being lined up with the fixed complementary components.

FIG. 6B shows the panel being secured to the wall by the press fitting between the plastic welded PET components and the fixed complementary components.

FIGS. 7 to 9 inclusive show a sequence used in a factory installed method:

FIG. 7A shows a drill and setting tool locating PET component in a pre-cut recess.

FIG. 7B shows disengagement of the drill and setting tool after the spin welding of the PET component in the recess so that the upper surface is flush with the surface of the panel.

FIG. 8A shows the two parts of the complementary component being screwed to a wall.

FIG. 8B shows the assembled two part complementary component secured in place.

FIG. 9A shows movement of the panel and one of its welded PET component towards one of the complementary components fixed to a support.

FIG. 9B shows the panel fixed to the wall by the interlocking of the welded PET component and the complementary component.

FIG. 10 showing the underside with and without the button and star washer.

FIG. 10a showing the top side with and without the button and star washer.

FIG. 11 shows the underside of the channel interface part.

FIG. 11a showing a side view of FIG. 11.

FIG. 11b showing a top view of the channel interface part of FIG. 11.

FIG. 12a shows the placement of a modified fastener into a setting tool

FIG. 12b shows the drill and setting tool being lowered onto the panel so that the outer cutting ring of the modified PET component can cut into the panel,

FIG. 12c shows the rotation of the setting tool by the drill and pressure applied to the PET component with the cross hatching representing the melding of part of the needle punched PET panel.

FIG. 12d shows disengagement of the setting tool form the now plastic welded PET component which has been sunk into the needle punched PET panel.

The next 4 views shows how the invention can be used to connect a Needle Punched PET baffle from a suspended channel using the channel interface part shown in FIGS. 11, 11a and 11b.

FIG. 13a shows a PET component plastic welded to the top surface of the Needle Punched PET baffle in a similar way to FIG. 5d, and the channel interface part about to be connected to the PET component.

FIG. 13b shows the channel interface part connected to the PET component by a bayonet fitting and the channel snap fitted over the channel interface part.

FIG. 13c shows a PET component plastic sunk into the top surface of the Needle Punched PET baffle and welded to the interior of the baffle (in a similar way to the welding f the component in FIG. 12d, and the channel interface part about to be connected to the PET component.

FIG. 13d shows the channel interface part connected to the now recessed PET component by a bayonet fitting and the channel snap fitted over the channel interface part.

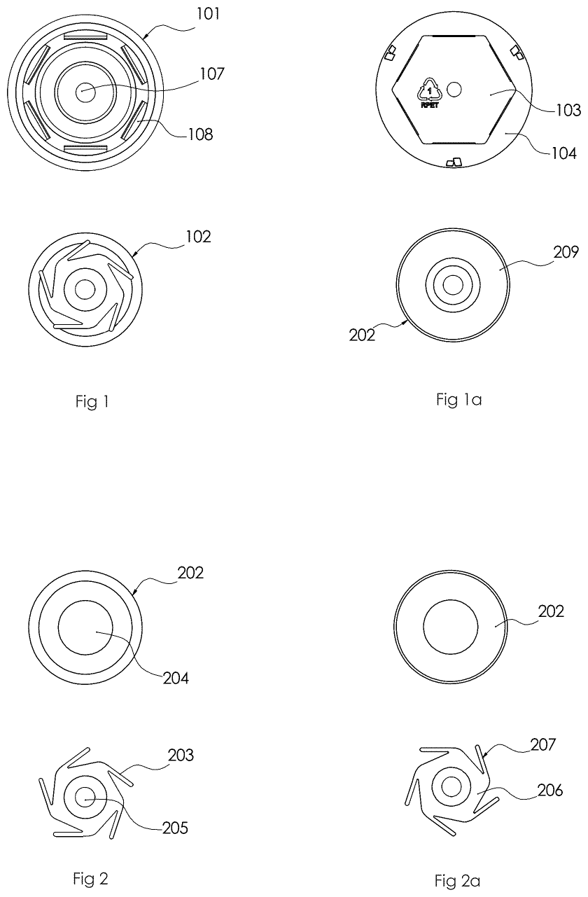

### DESCRIPTION OF THE PREFERRED EMBODIMENT(S)

The following description will describe the invention in relation to preferred embodiments of the invention, namely the fixing of PET panels to allow for recycling The invention is in no way limited to these preferred embodiments as they are purely to exemplify the invention only and that possible variations and modifications would be readily apparent without departing from the scope of the invention.

### NUMERALS

101—PET component.
102—complementary component.
103—reverse face of the PET component showing the hexagonal socket.
104—generally circular perimeter of the hexagonal socket.
106—circular ring.
107—central spike.
108—apertures surrounding the hexagonal socket.
109—bridging portions.
202—the outer portion of the complementary component.
203—the inner portion of the complementary component
205—a central aperture in the inner portion
204—a central aperture in the outer portion of the complementary component.
206—a pentagonal central body of the inner component.
207—a flexible arm of the inner component.
210—a support such as a wall.
301—a fastener such as a screw.
410—a PET panel to be affixed to a support
411—arrows representing the movement of the PET panel towards the spike 107
401—The resulting mark or detent in the panel 410
412—the direction of the panel as it is removed from the spike.
414—an arrow representing the release of the PET component from the complementary component so that it can be used in the next step.
501—a setting tool having a hexagonal end portion capable of fitting into the hexagonal socket at the rear face of the PET component.
502—an electric drill capable of rotating the PET component at high speed
505—an arrow representing the rotation of the setting tool and hence the PET component.
506—arrows representing the force applied to the PET come component as it is pressed against the panel.
507—arrows representing the removal of the setting tool from the now welded PET component.
601—arrows representing the movement of the PET panel towards the complementary component fixed to a substrate.
603—shows an air gap between the PET panel 410 and the support 210.
701—representing a precut recess in a PET panel.
801—representing the movement of a screw 301 towards the complementary component.
901—arrows representing the movement of the PET panel with its welded PET component moving towards the comp entry component fixed to a support.
1001—modified PET component with flange
1002—flange
1004—cutting ring
1101—channel interface part (a modified complementary component)
1105—step
1110—bayonet fitting
1201—the area of the needle punched PET underneath the PET component.
1301—suspended channel
1302—clips
1305—needle punched PET baffle

### Example 1—The Components

FIG. 1 shows the two fixing components. In this case both made from recycled PET. Though the complementary fixing component 102 at the bottom of FIG. 1 (designed to be attached the wall) can be made of any material and need not be the same as the PET component 101. Preferably the complementary fixing component has two parts 202 and 203 that if made from plastic can be injection moulded.

A PET component 101 as shown in FIG. 1 is generally circular an outline and having an upstanding spike 107 extending from one face thereof, so as to be able to mark a PET panel 410 when pressed against it. The reverse face shown at the top of FIG. 1A has a hexagonal recess 103 surrounded by a generally circular perimeter 104.

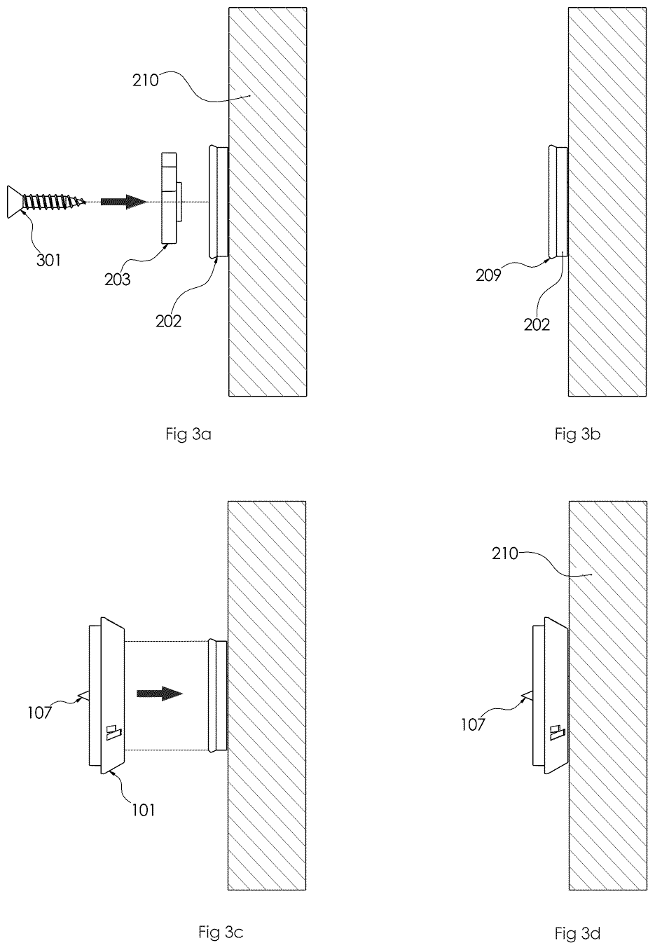

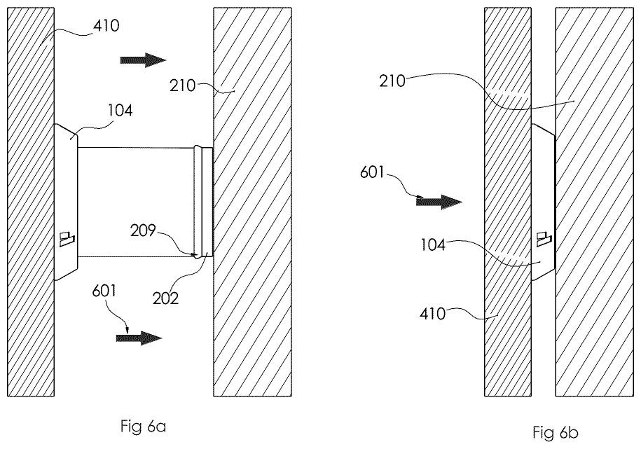

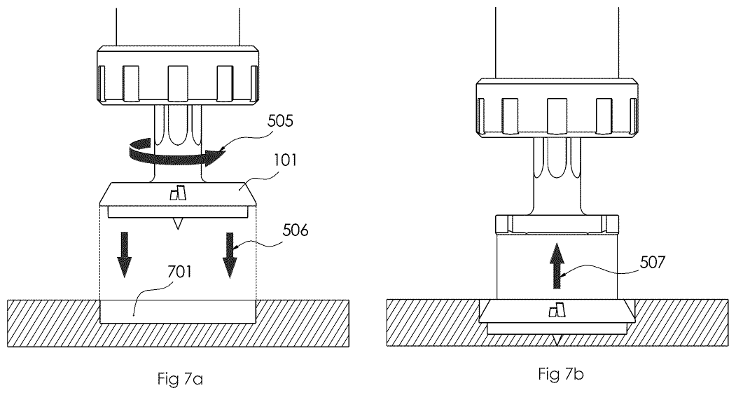

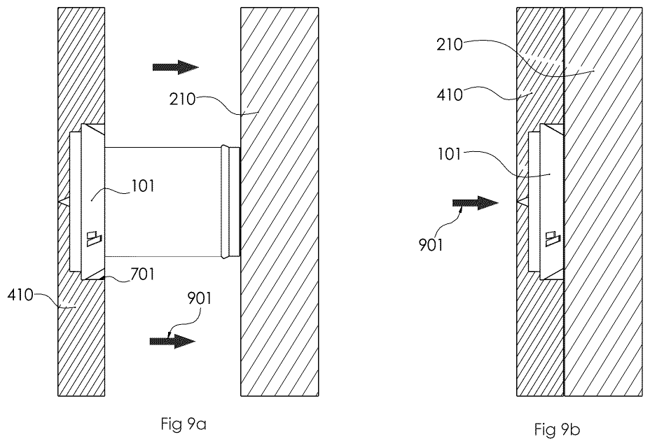

The central flexi part has a pentagonal body 206 with 5 spring arms 207 extended at a shallow angle from each side. This central part has an aperture 205 for a screw in its centre. The central part is a press fit inside the outer circular ring which also has a central aperture as shown. When the complementary fixing component 202 is fixed to a wall 210 (FIG. 3) then the corresponding PET component can be located over its outer circular ring 209, (temporarily in FIG. 3D, but more permanently in FIGS. 6B and 9B). If the two parts are not perfectly aligned the outer circular ring of the complementary component can move with respect to the fixed pentagonal body. This movement of the outer ring can be up, down or sideways, or at any angle of a clock face, providing a degree of “wiggle room” if the PET and complementary components are not perfectly aligned. This design allows pressure applied to the outer ring to cause one or more of the flexi arms to move inwards.

The complementary component thus provides a self-centring mechanism in the complementary component which is attached to the wall or other support. As shown in the drawings this can be moulded in two pieces, an outer circular component 202 with a large aperture 204 in the centre of the circular component, and an insert component 203 having a plurality of flexible arms 207 extending outwardly from a central body. The central body having a small aperture 205 to receive a screw or other fastener.

In its preferred form the central body is pentagonal in outline so that it has five spring arms extending at a relatively shallow angle from each of the sides, this has the advantage that the outer ring of the complementary component when attached to the wall can then move relative to the screw fastener, if the complementary component is not completely aligned with the corresponding PET fixing component on the back of the panel.

The complementary component when secured to the wall has the ability to allow its outer circular portion to move (up, down or sideways) in the plane of the wall sufficient to accommodate slight misalignment of a corresponding PET fixing component.

The central body is designed to be a snap fit into the outer circular portion, so that to the installer it appears that there are only two components (1) the complementary component to be attached to the wall and (2) the PET fixing component to be attached to the rear of the PET panel.

By way of example the PET fixing component has an outer diameter of 40 mm and an internal diameter of 30 mm. It is approximately 7 mm deep (excluding the spike 107—which protrudes about 3 mm above the circular side wall—just enough to create a detent when pressed into the back of the PET panel). This spike can be used to mark the fixing location on the back of the PET panel.

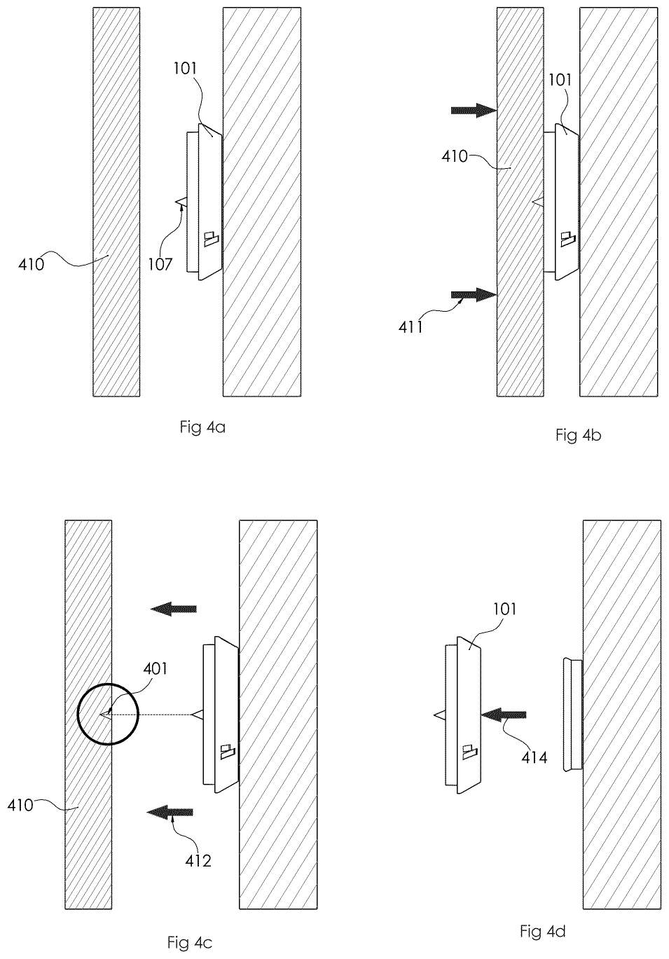

FIG. 1A shows that the rear face of the PET component has circular outer wall 104 and a generally hexagonal recess. The recess is defined by a hexagonal base and hexagonal sloping walls to provide a snap fit against the smaller diameter outer ring 209 of the complementary component. These sloping walls are designed to provide some degree of flexion as the PET component is pushed over the complementary component. This design assists in allowing the PET component to be temporarily attached to the complementary component fixed to a wall and the spike used to mark the relevant fixing location on the back of the PET panel as shown in FIGS. 4A to 4D. The press fitting needs to be sufficiently secure that it can be used to support the PET panel on the wall but also flexible enough to allow the panel with its plastic welded PET components to be pulled free of the fixed complementary components when the panel and PET components need to be recycled/upcycled.

### Example 2—On Site Installation of the Connectors

FIGS. 3 to 6 show the Steps Involved:

Installation typically starts by the complementary components 202 being attached to a wall by screw fasteners 301 as shown in FIG. 3A. For a typical panel we suggest fixing nine such complementary components 202 to the wall in three rows of three. (In the drawings we show only one PET fastener being connected to one complementary fastener but in practice all 9 PET components would be press fitted to the 9 complementary components).

The next step is to temporarily push fit the PET fixing component 101 over the top of the corresponding complementary component 202 as shown in FIGS. 3C and 3D, with the spike 107 of the PET component facing outwards as shown in FIG. 4A.

FIG. 4B shows the virgin PET panel 410 being pressed against the complementary fasteners 202 on the wall 210 so that the spikes create indents on the rear surface of the panel to locate the positions 401 of the PET fixing components. The PET fixing components 101 are then removed from the wall and can then be friction welded to the back of the panel at the desired locations 401 indicated by the indents in the panel.

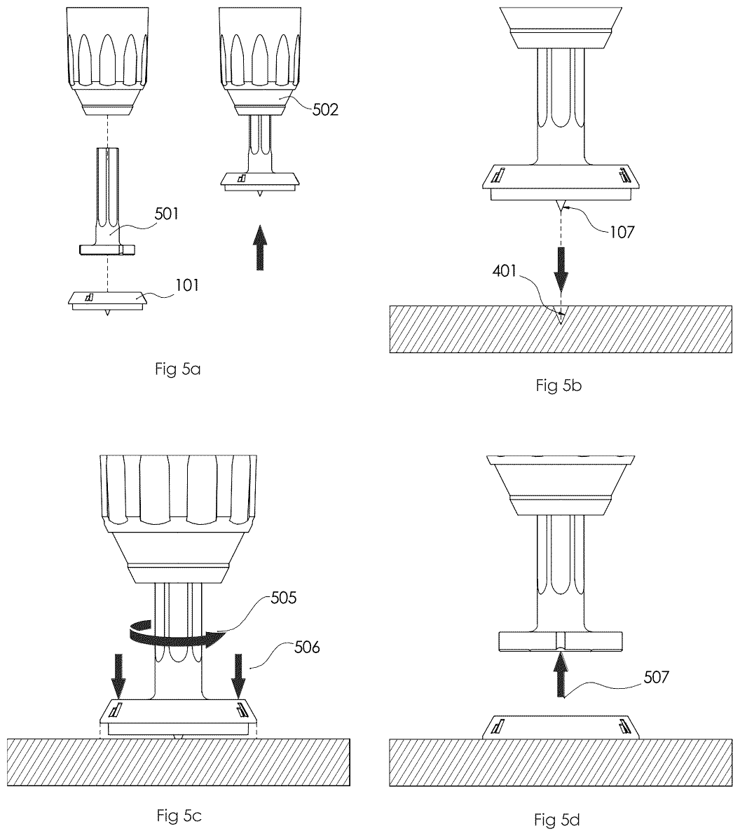

The friction welding step involves the use of the PET fixing components 101 (preferably retrieved from the wall) and placing them in turn in a setting tool 501 held in the chuck of a drill 502 in manner shown in FIG. 5 so that the spike 107 can be located in a relevant detent 401 on the back of the panel. The setting tool has a hexagonal end portion intended to fit into the hexagonal recess on the back of the PET portion. By spinning the PET fixing component at high speed and low pressure—the friction heating between the component and the PET panel causes the panel and the component to be welded together. We have found that for PET panels of different densities the rotational speed provided a hand held electric drill is sufficient to allow plastic welding between the PET component and the PET panel. For example, the rotational speed could be between 100 rpm and 2000 rpm depending upon the load applied on the drill as it is pressed against the panel. The lower the density of the panel the more likely the PET component is to sink into the panel as the fibres in the panel melt.

FIGS. 5A to 5D shows the PET fixing component placed in a setting tool 501 attached to an electric drill to allow it to be friction welded to the rear face of a PET panel. We have found that depending on the speed of the drill 502 only a slight pressure 506 is needed to be applied to the PET fixing component as it is rotated and pressed against the PET panel. As best seen in FIGS. 5 and 1 the PET component has a circular protruding ring 106 (slightly inboard of the circular perimeter of the PET component 101, which can press into the back of the PET panel and partly melt and/or weld to the rear of the PET panel. It does not matter if it is the PET panel that melts or the PET comment or both, the result is that they can be friction welded together without the need of any adhesive. In addition, these Figures show the central spike which is taller than the protruding ring so that it can be located in the correct position on the panel indicated by the depressions 401 in the panel (see below).

FIG. 5C shows the electric drill 502 being used to rotate one of the PET fixing components 101 in the direction 505 when it is pressed against the rear surface (seen as the upper surface in FIG. 5C) of a PET panel, the PET component being held by the setting tool and being rotated by the electric drill to friction weld it to the PET panel. FIG. 5d shows the removal of the setting tool in direction 507 leaving the PET component welded to the PET patent.

FIG. 6A represents one of the typically nine PET fixing components friction welded to the rear face of the PET panel 410 so that the panel can now be placed onto the wall and press fitted to the complementary fixing components 202 shown by the following sequence.

The panel 410 is held close to the wall (FIG. 6A) and then pushed towards the wall 210 (FIG. 6B) so that the PET fixing components 101 on the back of the panel can engage with the complementary components 202 fixed to the wall. A slight tap with heel of the hand is usually enough to lock the components together as shown in FIG. 6B so that the hexagonal socket 104 fits over and now hides the complementary component 102.

As explained above if one or more of the fixed complementary components is not perfectly aligned with the location of the PET components on the back of the panel—then a small amount of adjustment can be accommodated by the movement of the outer ring 202 relative to the pentagonal centre component 203 by pushing against one or more of the flexi arms 207. In this version, the PET panels can be supplied with a number of separate (loose) PET fixing components and complementary fixing components (and if needed, screws) and instructions on how to attach the PET panel to a support using these complementary fixing components as outlined above.

We have tested the friction welding of the PET component to all of the different grades and thicknesses of PET panels we produce and this in-situ method is suitable for all of our grades of PET panel.

### Example 3—Air Gap

As shown in FIG. 6B the PET components being mounted on the surface of the rear face of the PET panel allows an air gap 603 to be created between the PET panel 410 and the support 210. This air gap enhances the sound reduction performance of the mounted PET panel.

### Example 4—Factory Installed Components

In this arrangement the PET fixing components can be welded to the surface of the PET panels in the factory, so that the PET panels can be supplied to the installer with this step already completed. We prefer to do this using a robotic arm to spin weld the PET fixing component so the PET panel at predetermined locations. This is similar to the previous example except that it omits the marking of the PET panels by the temporary location of the PET components. Instead, the installer can be supplied with a template to mark the spots where holes need to be drilled in a wall to correspond to the location of the PET components. A suitable template could be PET panel with pre-drilled holes corresponding to the location of the PET components.

Alternatively, the installer could be provided with instructions to measure and mark the drilling locations, e.g. by use of a laser or other measuring device.

### Example 5—FIGS. 7 to 9 Flush Mounted on Pre-Cut Recesses

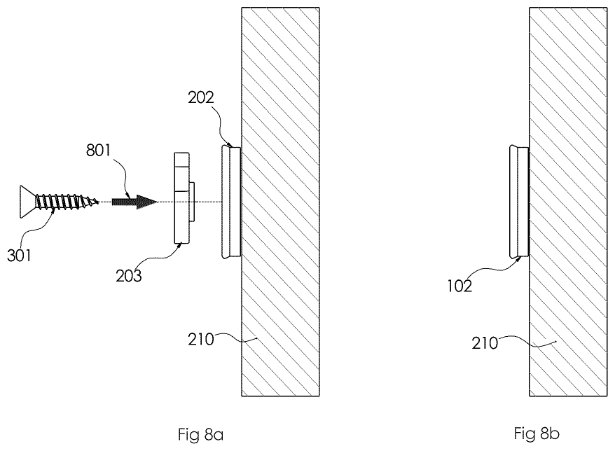

In an alternative arrangement the PET fixing components can be welded to the PET panels in the factory, so that the PET panels can be supplied to the installer with this step already completed. We prefer to do this using a robotic arm to spin weld the PET fixing component so the PET panel at predetermined locations. In this example the locations can be pre-cut recesses 701 (FIG. 7A). The PET fixing components can then be welded to the panel by locating them in the pre-cut recesses 701 as shown in FIGS. 7A and 7B by rotating and applying slight pressure 506. The resulting panels have the PET components flush mounted for ease of stacking and transport as in FIG. 7B (after the tool 501 is removed). The installer can then mark the location of the complementary components and attach them to the support—as described in the previous example. See FIGS. 8a and 8b. Then press the panel with its flush mounted PET components into the wall mounted complementary components as in FIGS. 9a and 9b.

However, this means that the panels when mounted to a support will not have an air gap. If an air gap is desired then the complementary components could have higher side walls to ensure the PET panel is held away from the surface of the wall.

### Example 6—Flush Mounted Without a Pre-Cut Recess

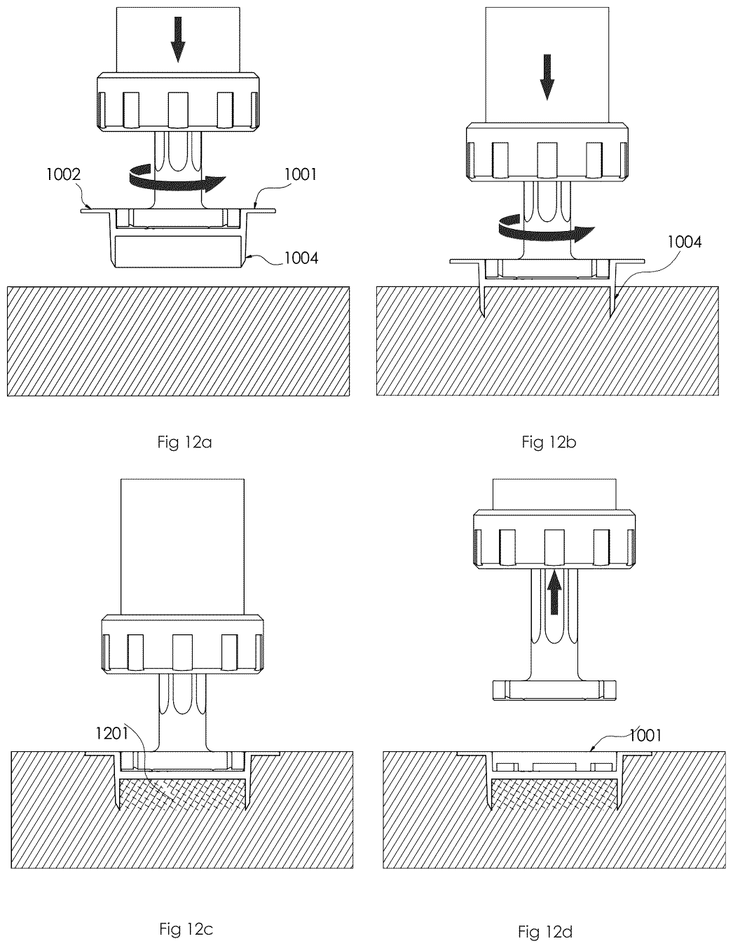

### See FIGS. 12a to 12d.

As mentioned below the heat generated by spin welding allows the PET fixing component to cause the PET fibres in the PET panel to melt so that PET fixing components sink into the PET panel. We have found that it is not necessary to pre-cut a recess as the heat generated by the plastic welding allows for secure welding of the melted fibres of the less dense panel compared to the much denser PET fixing component. Since the plastic welding operation melts the fibres in the plastic it is sometimes necessary to prevent the spinning PET fixing component from sinking too far into the panel. With a robotic arm it is desirable to place a limit on how deep the spinning PET fixing component can sink into the panel.

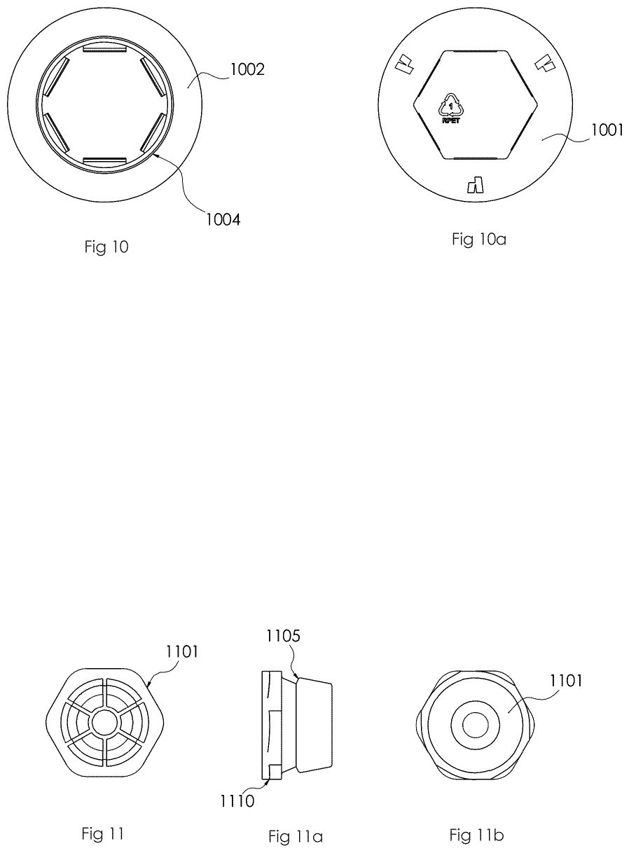

FIG. 10 shows a modified PET component 1001 having an outer flange 1002 and a cutting ring 1004 to facilitate the entry of the modified PET component into the panel. This is best seen in FIGS. 12 to 12d as the cutting ring enters the panel. As the modified PET component enters the panel the portion of the panel direct below the PET component melds with the PET panel to cause it to be friction welded in place.

What the cutting ring 1004 of the self-recessing version 1001 is doing during the insertion is pre-cutting a perimeter cut, allowing the area 1201 under the PET component 1001 to freely compress, as it is no longer connected to the surrounding material, as the PET component 1001 is inserted, the cutting ring 1004 inevitably becomes a friction weld surface as does the underside of the topmost outer flange 1002. This self-recessing version has a larger friction weld surface area than the PET component 101 of FIG. 5d.

Because the PET components can be fixed to the back of the set of panels before being sent to the installer there are a number of different ways the installer can locate the positions of the complementary components as mentioned in Example 4 above.

### Example 7—Suspended Panels

### Bayonet Clip and Stud.

FIGS. 11, 11a, and 11b show a slightly different complementary component 1101 in the form of a channel interface part. It can be used to connect a needle punched PET baffle 1305 to a suspended channel 1301. In this example the baffle is shown as rectilinear but baffles can be produced in a variety of shapes. Such PET baffles are often used for sound absorption and for decoration as well.

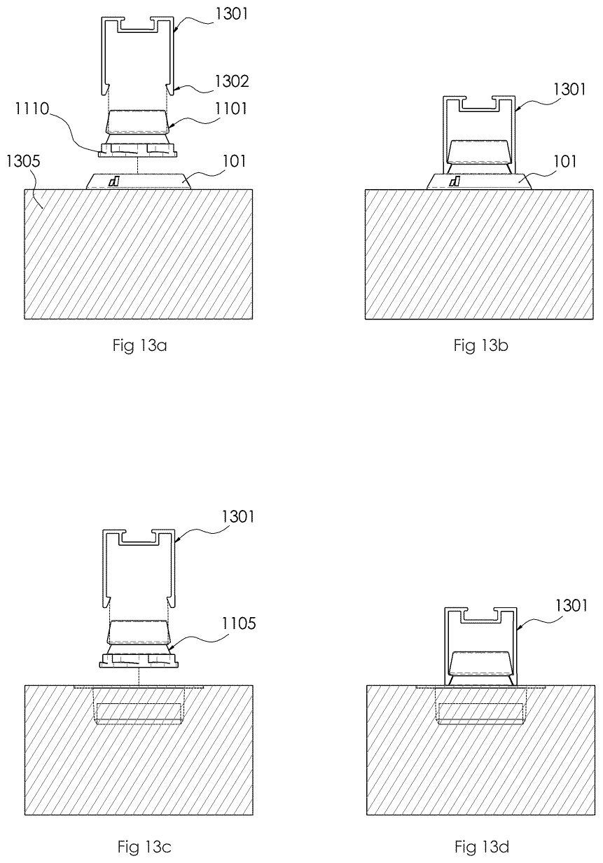

FIGS. 13a to 13d show the connection sequence for both the externally mounted PET component and the flush mounted PET component.

By using the PET component friction welded to the baffle (as described in the examples above) it is possible to use a channel interface part 1110 which can be mechanically connected to the interior of the PET component. We prefer to use a bayonet fitting to the interior of the PET component so that the channel 1301 can be clipped over the channel interface part 1101 which protrudes from the PET component. Other types of mechanical connections could be used, e.g. a screw threaded connection between the two parts, so long as no adhesive is used.

The channel is typically an extruded aluminium section 1301 suspended by wires from the structure over. It can have internal clips 1302 to clip over the step 1105 formed in the channel interface part 1101.

### Example 8—Recycling

When the PET is at the end of its useful life (for whatever reason) it can be easily unclipped from it support or supporting structure and then recycled. To recycle, it can be cut or shredded without the need to remove the PET fixing components as the panel or components are not contaminated by adhesive. It is desirable that the shredded or pelletised output is substantially homogeneous. When it is in small enough pieces it can then be melt and spun into fibres, which can then be inserted into a needle punching line to form a new needle punched panel or fabric. Alternatively, some of the shredded plastic can be used in an injection moulding process to create new injection moulded components such as the PET fixing components described herein.

### Advantages

The methods of fixing PET panels to a support as described allows for recycling by using fixing components of the same plastic as that of the PET panel thereby avoiding the need to separate the panel and the fixing components during recycling.
The plastic welding of the PET components and the use of a mechanical connection to the complementary component means that no adhesive is used on the panel so that the panel can lawfully be recycled.
Ease of fixing the complementary component to the wall.
Ease of friction welding the PET fixing components to the panel.
Ability to provide an air gap between the panel and a support.

### Variations

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

Whilst spin welding has proved to be the most effective form of plastic welding of PET components to needle punched PET panels, other forms of plastic welding could be used depending upon the density of the panels.

The geometry of the components can be varied-in particular the hexagonal socket could be replaced by other shapes.

1. A PET fixing component capable of being attached to a needle punched PET product by plastic welding without the use of any glue which would otherwise contaminate the panel and prevent it from being recycled.

2. A PET fixing component capable of being attached to a needle punched PET product by plastic welding, wherein the product is a panel, and the depth of the PET component is less than the thickness of the panel.

3. A needle punched PET panel having a plurality of PET fixing components as claimed in claim 1, attached to the panel by plastic welding.

4. A needle punched PET panel as claimed in claim 3, wherein the plurality of PET fixing components are attached in such a way as to stand proud of the surface to assist in creating an air gap between the panel and a support to which it is to be attached.

5. A needle punched PET panel as claimed in claim 3, wherein the plurality of PET fixing components are positioned within the panel and do not protrude above the surface of the panel to which they are fixed.

6. A PET fixing component or a panel having a plurality of fixing components attached thereto as claimed in claim 3, wherein the or each PET fixing component is capable of being press fitted to a complementary component designed to be fixed to a wall or other surface.

7. A PET fixing component as claimed in claim 1, wherein the PET component has a mechanical connection suitable for connection to a stud which can be connected to an overhead channel capable of suspending needle punched PET products.

8. A PET fixing component as claimed in claim 1, wherein the PET component is injection moulded.

9. A pair of fixing components for attaching a needle punched PET product to a support, wherein the components are injection moulded from PET with a first component having a circular outer wall surrounding a recess, the recess being designed to receive a second component, so that the first and second components can be press fitted together.

10. A pair of fixing components for attaching a needle punched PET product to a support as claimed in claim 9, wherein the components are injection moulded from recycled PET.

11. A pair of fixing components for attaching a needle punched PET product to a support as claimed in claim 9, wherein the product is a panel and the second component consists of two parts, an inner body and an outer ring, the inner body having an aperture for a fastener and a plurality of spring arms to allow the outer ring to move relative to the aperture when it is fixed to a support by a fastener.

12. A method of fixing a needle punched PET product to a support in which a PET fixing component is attached to the rear surface of the PET product by plastic welding, and a complementary fixing component is attached to a support, so that the PET fixing component and the complementary component can be attached together by a mechanical connection without the use of glue contaminating the needle punched PET product.

13. A method of fixing a needle punched PET product to a support as claimed in claim 12, wherein the support is a wall, and the product is a panel.

14. A method of fixing a needle punched PET product to a support as claimed in claim 12, wherein the support is a suspended channel and the product is a baffle.

15. A method of recycling a needle punched PET panel attached to a support by a plurality of pairs of fixing components as claimed in claim 2, wherein the panel can be separated from the support to disconnect the panel and its welded PET components from the complementary components, so that the panel plus its PET components can be recycled by chopping and/or shredding so that the recycled material can be re-used.

16. An installation comprising a support having one or more needle punched PET panels or baffles attached thereto by a plurality of pairs of fixing components as claimed in claim 9.
